(19) United States
(12) Patent Application Publication
(10) Pub. No.: US 2021/0142327 A1
(43) Pub. Date: May 13, 2021

(54) FINANCIAL STATE INDICATOR

(71) Applicant: Wells Fargo Bank, N.A., San Francisco, CA (US)

(72) Inventors: Anthony Burton, Charlotte, NC (US); Chris Kalaboukis, San Jose, CA (US); Orsolya Oldroyd, Walnut Creek, CA (US); Margot Lockwood-Stein, Palo Alto, CA (US); Paul Vittimberga, Oakland, CA (US)

(21) Appl. No.: 15/611,115

(22) Filed: Jun. 1, 2017

Related U.S. Application Data
(60) Provisional application No. 62/491,296, filed on Apr. 28, 2017.

(51) Int. Cl. G06Q 20/40

(52) U.S. Cl. CPC G06Q 20/4016; G06Q 40/04

(57) ABSTRACT

Examples described herein relate to apparatuses and methods for a financial institution computing system of a financial institution to generate a financial indicator of a non-publically traded company. In some arrangements, the financial institution computing system receives from a user device associated with the user a request message indicating that the user is initiating the potential transaction with the non-publically traded company via the user device before a user enters into a transaction with the non-publically traded company. In addition, the financial institution computing system determines the financial indicator of the non-publically traded company based on transaction history of the non-publically traded company. Furthermore, the financial institution computing system transmits to the user device the financial indicator.

### CROSS-REFERENCE TO RELATED APPLICATIONS

This application claims the benefit of priority to U.S. Application No. 62/491,296, filed Apr. 28, 2017, entitled “FINANCIAL STATE INDICATOR”, which is hereby incorporated by reference in its entirety.

### BACKGROUND

Financial state indicators reflect financial health of a company and are typically determined based on analysis of various relevant aspects of the company. Generally, financial state indicators are presented in an easily digestible manner (e.g., a score, pass/fail, or the like) to represent a result of considerably complex investigation into the company's operations. A potential customer who is contemplating on entering into a transaction with the company can make informed decisions regarding the transaction based on such financial state indicators. For instance, the potential customer can choose to complete the contemplated transaction with the company if the customer deems the financial state indicators of the company to be satisfactory. Conventionally, financial institutions do not provide any financial indicators for non-publically traded companies, due to the difficulties in obtaining relevant financial data, as the non-publically traded companies are not under an obligation to disclose pertinent financial information. Therefore, information asymmetry occurs as a potential customer engages in a transaction with a non-publically traded company, thus increasing risk faced by the potential customer.

### SUMMARY

In one arrangement, a method for a financial institution computing system of a financial institution for generating a financial indicator of a non-publically traded company for a potential transaction between a user and the non-publically traded company. The method includes receiving, by the financial institution computing system from a user device associated with the user, a request message indicating that the user is initiating the potential transaction with the non-publically traded company via the user device. The method further includes determining, by the financial institution computing system, the financial indicator of the non-publically traded company based on transaction history of the non-publically traded company. Still further, the method includes transmitting, by the financial institution computing system to the user device, the financial indicator.

In one arrangement, a financial institution computing system includes a network interface structured to facilitate data communication via a network, a memory, and a processing circuit comprising a processor. The processing circuit configured to receive, from a user device associated with the user, a request message indicating that the user is initiating the potential transaction with the non-publically traded company via the user device. The processing circuit is further configured to determine the financial indicator of the non-publically traded company based on transaction history of the non-publically traded company. The processing circuit is further configured to transmit the financial indicator to the user device.

In one arrangement, a non-transitory processor-readable medium has processor-readable instructions stored thereon, such that when executed by a processor of a financial institution computing system, the processor is configured to receive, from a user device associated with the user, a request message indicating that the user is initiating the potential transaction with the non-publically traded company via the user device. The processor is further configured to determine the financial indicator of the non-publically traded company based on transaction history of the non-publically traded company. In addition, the processor is configured to transmit the financial indicator to the user device.

In one arrangement, a method for a user device to present a financial indicator of a non-publically traded company for a potential transaction between a user associated with the user device and the non-publically traded company is described. The method includes sending, by the user device to the financial institution computing system, a request message indicating that the user is initiating the potential transaction with the non-publically traded company via the user device. The method further includes receiving, by the user device from the financial institution computing system, the financial indicator, wherein the financial indicator is determined based on transaction history of the non-publically traded company. The method further includes displaying, by the user device via a user interface of the user device, the financial indicator to the user before completion of the potential transaction.

These and other features, together with the organization and manner of operation thereof, will become apparent from the following detailed description when taken in conjunction with the accompanying drawings.

### BRIEF DESCRIPTION OF THE FIGURES

FIG. 1 is a diagram of a system for determining a financial indicator of a non-publically traded company according to some arrangements.

FIG. 2A is a diagram of a user device of the system of FIG. 1 according to some arrangements.

FIG. 2B is a diagram of a financial institution of the system of in FIG. 1 according to some arrangements.

FIG. 3 is a flow diagram illustrating a method for determining a financial indicator according to some arrangements.

FIG. 4A and FIG. 4B are interface display diagrams illustrating interactive interfaces for receiving user input in connection with a method for determining a financial indicator according to some arrangements.

FIGS. 5A-5D are interface display diagrams illustrating interactive interfaces for receiving user input in connection with a method for determining a financial indicator according to some arrangements.

### DETAILED DESCRIPTION

Traditionally, financial indicators (e.g., financial scores, confidence scores, financial state indicators, or the like) of a non-publically traded company are not available to a potential customer who wishes to engage in a transaction with the non-publically traded company. Ratings of a non-publically traded company generally are determined based on subjective reviews (e.g., social media reviews and ratings) instead of actual financial factors indicative of the non-publically traded company's financial operations. Specifically, the potential customer who is at a point of sale (POS) would have no information about the non-publically traded company prior to completing the transaction. In other words, the potential customer conventionally cannot be made aware of the financial viability of the non-publically traded company, especially at the time that the potential customer is contemplating whether to enter into the potential transaction (e.g., at the POS, on a computer, on a mobile device, and/or the like). It follows that the risk increases tremendously for the potential customer who enters into a transaction without learning any indication as to whether the non-publically traded company is able to fulfill its obligations under the transaction.

Financial indicators of a non-publically traded company can provide insight to a potential customer so that the customer can make an informed decision about whether to enter into a potential transaction with the non-publically traded company prior to completing the potential transaction, for example, at the POS. In the digital age in which customers prefer to make immediate transactions digitally (e.g., with a user device such as a smartphone), immediate feedback relative to the financial health of the non-publically traded company on the customer's device as the transaction is taking place becomes crucial to manage the customer's risks.

However, due to the fact that the non-publically traded company may not release the pertinent information, the financial data based on which any financial indicators can be determined is scarce, if such data exists at all. Therefore, when the potential customer wishes to digitally enter into a potential transaction with the non-publically traded company with which the potential customer is unfamiliar, it would be impossible for the potential customer to search for relevant information (e.g., at the POS) without spending considerable time. The potential customer may not even attain any useful information at all. Worse yet, the potential customer may obtain an incomplete picture of the financial soundness of the non-publically traded company through subjective customer ratings, thus skewing the decision-making process. In the fast-paced world today, immediate and accurate feedback as a response to the potential customer's interest to enter into a potential transaction with the non-publically traded company can significantly improve risk management for the potential customer.

Arrangements described herein relate to apparatuses, systems, and methods for presenting a potential customer of a non-publically traded company with an effective financial indicator in response to the potential customer's interest to conduct a potential transaction with a non-publically traded company. Publically unavailable financial data, such as transaction history involving the non-publically traded company, is gathered and stored by a financial institution computing system. The transaction history includes, but is not limited to, information concerning the non-publically traded company's previous transactions (e.g., with other customers, with other entities, or the like). The financial institution computing system determines a financial indicator based on the transaction history to present to the potential customer before the potential customer is able to complete the transaction (e.g., before the potential customer obligates to transactions to pay the non-publically traded company). The potential transaction can be a digital transaction (e.g., a mobile wallet transaction, an online credit/debit card transaction, digital POS transaction, or the like) initiated by the potential customer using a digital device.

In some examples, the financial institution computing system stores the transaction history locally on an associated database given that the financial institution computing system facilitated or otherwise processed the transactions shown in the transaction history. In such examples, the non-publically traded company and/or the other parties to the transactions are customers of the financial institution operating the financial institution computing system. In some examples, the financial institution computing system receives the transaction history from a computing system of the non-publically traded company or from another financial institution computing system that serves the non-publically traded company. The financial institution computing system processes such sensitive, proprietary, and publically unavailable data to determine the financial indicator. The user device shows only the financial indicator to the user. The transaction history is not transmitted to the user device. By determining the financial indicator at the financial institution computing system, privacy and security of the transaction history can be better protected. Thus, in addition to immediately providing an accurate financial indicator, the arrangements herein can further protect the transaction history used to determine the financial indicators.

Furthermore, given that a tremendous amount of transactions can take place at any given time, the financial institution computing system is configured to access the most up-to-date transaction history of the non-publically traded company. For example, the financial indicator can be dynamically determined in response to receiving a notification that the potential customer is contemplating on entering into a potential transaction with the non-publically traded company, for example, to assure that the most recently obtained transaction history is weighed in determining the current financial indicator, or to assure that the potential customer can obtain the most up-to-date information. In conjunction with the processing power and the storage capabilities available to the financial institution computing system, such arrangements can analyze a tremendous amount of transaction history in a complex manner to provide the accuracy and the speed needed to improve user experience with respect to digital transactions, for example, online or at the POS.

In some examples, the transaction history refers to various aspects of previous transactions between the non-publically traded company and customers of the non-publically traded company or other companies or entities. The transaction history is indicative of one or more of the following factors relative to the financial institution computing system that can be weighed in determining the financial indicator: transaction amounts, number of transactions, number of customers, rate of change (increase or decrease) in the number of customers, duration of customer relationship, number of refunds, amount of refunds, or the like. In some examples, the transaction amounts include one-time payments and/or recurring (e.g., daily, weekly, monthly, annually, or the like) payments. In some examples, the number of transactions includes one-time payments and/or recurring payments.

In some examples, the transaction history includes deposits by the non-publically traded company, withdrawals by the non-publically traded company, or liability incurred by the non-publically traded company. Particularly, the transaction history can reflect one or more of cash flow, assets, liabilities, investments, profits, or the like. According to a non-limiting example, funds raised by the non-publically traded company, earnings (e.g., payments to) of the non-publically traded company, and/or the like can correspond to deposits. In addition, loans and financing deals with other companies or entities can also correspond to deposits. Expenditures, legal fees, government fines, loan, or the like can correspond to withdrawals and/or incurred liability.

The factors shown in the transaction history can be categorized based on types of goods and/or services, geographical region, time, and/or the like to support an in-depth analysis of the transaction history.

The transaction history of multiple non-publically traded companies is stored in a database of at least a financial institution computing system. In some arrangements, the non-publically traded companies are categorized based on industry (e.g., retail sale, food/beverage, whole sale, music, financial products/services, or the like). The financial indicator is determined differently based on the industry that the requested non-publically traded company belongs. For instance, in a media content streaming industry, the number of customers paying monthly payments and the amount of the monthly payments are weighed more heavily as compared to other factors shown in the transaction history. In another example, in a high-tech startup industry, investment or financing received that correspond to deposits are weighed more heavily as compared to other factors shown in the transaction history.

In some arrangements, the financial indicator of the target non-publically traded company is determined in relation with financial history of other non-publically traded companies in the same field. In other words, the financial indicator corresponds to relative financial health of the target non-publically traded company as compared to other non-publically traded companies in the same or similar field.

FIG. 1 is a diagram of an example of a system 100 for determining a financial indicator of a non-publically traded company 150 according to some arrangements. Referring to FIG. 1, the user 101 is a potential customer who wishes to enter into the potential transaction with the non-publically traded company 150. The user 101 can be any entity (e.g., an individual, a company, or the like) that is capable of paying for goods or services offered by the non-publically traded company 150. The non-publically traded company 150 can be any non-publically traded entity (e.g., a company, a merchant, or the like) that provides goods or services. Therefore, financial information concerning the non-publically traded company 150 may be scarce. While the non-publically traded company 150 is depicted as a brick and mortar location in FIG. 1, it will be appreciated that the non-publically traded company 150 may not be associated with a brick and mortar location.

The potential transaction is a possible transaction digitally initiated and not yet completed. For example, the potential transaction is at a stage in which the user 101 has identified, through a user interface of a user device 110, at least the non-publically traded company 150 as the other party to the potential transaction. Before the financial indicator is received by the user device 110, the potential transaction is not completed (e.g., payment from the user 101 has not yet been made to the non-publically traded company 150). The potential transaction is not an investment in some examples. In other examples, the potential transaction can be an investment.

In some arrangements, the user 101 is an account holder of at least one financial account at the financial institution 140. The financial institution 140 facilitates various types of transactions between the user 101 and other parties, including but not limited to the non-publically traded company 150. The user 101 is associated with (e.g., uses) the user device 110 for transactions, including the potential transaction. That is, the user 101 operates the user device 110 to access financial products and/or services provided by the financial institution 140. According to a non-limiting example, the user 101 can use a mobile wallet or online payment features provided by the financial institution 140 to pay for the goods or services offered by the non-publically traded company 150. The mobile wallet or online payment features are provided through software applications on the user device 110.

The user device 110 is connected to the financial institution 140 (e.g., a financial institution computing system 242 of FIG. 2) via a communication network 120. The communication network 120 is any suitable Local Area Network (LAN) or Wide Area Network (WAN). For example, the communication network 120 can be supported by Frequency Division Multiple Access (FDMA), Time Division Multiple Access (TDMA), Code Division Multiple Access (CDMA) (particularly, Evolution-Data Optimized (EVDO)), Universal Mobile Telecommunications Systems (UMTS) (particularly, Time Division Synchronous CDMA (TD-SCDMA or TDS) Wideband Code Division Multiple Access (WCDMA), Long Term Evolution (LTE), evolved Multimedia Broadcast Multicast Services (eMBMS), High-Speed Downlink Packet Access (HSDPA), and the like), Universal Terrestrial Radio Access (UTRA), Global System for Mobile Communications (GSM), Code Division Multiple Access 1× Radio Transmission Technology (1×), General Packet Radio Service (GPRS), Personal Communications Service (PCS), 802.11X, ZigBee, Bluetooth, Wi-Fi, any suitable wired network, combination thereof, and/or the like. The communication network 120 is structured to permit the exchange of data, values, instructions, messages, and the like between the user device 110 and the financial institution 140 (e.g., a financial institution computing system 242 of FIG. 2).

One or more transaction information databases 160a-160c may be available such that the financial institution 140 (e.g., a financial institution computing system 242 of FIG. 2B) can access transaction history of the non-publically traded company 150 for determining the financial indicator. The transaction history of the non-publically traded company 150 may be private to the non-publically traded company 150. In other words, the transaction history may be non-public and cannot be access by anyone without proper authorization. Each of the transaction information databases 160a-160c stores financial data (e.g., transaction history) of multiple non-publically traded companies, including the non-publically traded company 150. As described, some portions of the transaction history stored in each of the transaction information databases 160a-160c may differ while other portions of the transaction history may overlap.

Based on the information in one or more transaction information databases 160a-160c, the financial institution 140 (e.g., a financial institution computing system 242 of FIG. 2B) determines the financial indicator of the non-publically traded company 150 to be presented to the user 101 through the user device 110.

In some arrangements, the transaction information database 160a is part of or is operatively coupled to the financial institution 140 and represents local storage for the transaction history of the non-publically traded company 150. In such arrangements, the financial institution 140 collects transaction history to which the financial institution 140 has access. For example, the financial institution 140 itself may have processed some or all of the transactions shown in such transaction history. For example, the non-publically traded company 150 and/or other parties to the transactions comprising the transaction history can be customers of the financial institution 140. The financial institution 140 stores the transaction history of such transactions as art of processing the transactions.

In some arrangements, the transaction information database 160b is on a computing system 130 that is remote from (e.g., residing on a different network node) the financial institution 140 (e.g., a financial institution computing system 242 of FIG. 2B). The transaction information database 160b can be a transaction history repository independent from the financial institution 140 (e.g., independent from the transaction information database 160a) and can be accessed by the financial institution (e.g., a financial institution computing system 242 of FIG. 2B) through the communication network 120. According to a non-limiting example, the computing system 130 is a computing system of another financial institution (separate from the financial institution 140) that serves the non-publically traded company 150 and/or the other parties to transactions stored in the transaction information database 160b. The non-publically traded company 150 and/or the other parties can be customers of the financial institution associated with the computing system 130.

Therefore, the non-publically traded company 150 can be a customer of the financial institution 140, the financial institution associated with the computing system 130, or both. The other parties to the previous transactions can be a customer of the financial institution 140, the financial institution associated with the computing system 130 (and the transaction information database 160b), or both.

In some arrangements, the transaction information database 160c is local to a computing system associated with the non-publically traded company 150 in the transaction information database 160c. For instance, the non-publically traded company 150 itself can maintain records of the transactions that the non-publically traded company 150 had previously entered. The non-publically traded company 150 can maintain such record keeping practice as a part of its regular course of business. The transaction history in the transaction information database 160c is relatively more complete in the sense that the records are stored and managed by the non-publically traded company 150 itself.

FIG. 2A is a diagram of an example of the user device 110 of the system 100 set forth in FIG. 1 according to some arrangements. FIG. 2B is a diagram of an example of the financial institution 140 of the system 100 set forth in FIG. 1 according to some arrangements. The financial institution 140 includes one or more of a bank branch, loan office, mortgage office, financial services office, retail office, automatic teller machine (ATM) location, a combination thereof, and/or the like. The financial institution 140 has at least one associated financial institution computing system 242.

The financial institution 140 provides financial products and services such as, but not limited to, credit card accounts, mobile wallet, checking/saving accounts, retirement accounts, mortgage accounts, loan accounts, investment and financial accounts, and the like to the user 101 via the financial institution computing system 242. The financial institution computing system 242 includes a processor 244 and a memory device 246. The processor 244 is implemented as a general-purpose processor, an Application Specific Integrated Circuit (ASIC), one or more Field Programmable Gate Arrays (FPGAs), a Digital Signal Processor (DSP), a group of processing components, or other suitable electronic processing components. The memory 246 (e.g., Random Access Memory (RAM), Read-Only Memory (ROM), Non-volatile RAM (NVRAM), Flash Memory, hard disk storage, etc.) stores data and/or computer code for facilitating at least some of the various processes described herein. The memory 246 includes tangible, non-transient volatile memory, or non-volatile memory. The memory 246 stores programming logic that, when executed by the processor 244, controls the operations of the financial institution computing system 242. In some arrangements, the processor 244 and the memory 246 form various processing circuits described with respect to the financial institution computing system 242 (e.g., the financial indicator management circuit 260).

As shown, the financial institution computing system 242 includes a network interface 248. The network interface 248 is structured for sending and receiving of data over the communication network 120 (e.g., to and from the user device 110, etc.). Accordingly, the network interface 248 includes any of a cellular transceiver (for cellular standards), local wireless network transceiver (for 802.11X, ZigBee, Bluetooth, Wi-Fi, or the like), wired network interface, a combination thereof (e.g., both a cellular transceiver and a Bluetooth transceiver), and/or the like.

The financial institution computing system 242 includes an account database 250 that stores customer information and account information relating to one or more accounts held by the user 101 with the financial institution 140. In this regard, more than one financial institution (such as, but not limited to, the financial institution 140) with an associated financial institution computing system (such as, but not limited to, the financial institution computing system 242) can be communicably coupled to the components of FIG. 2 over the communication network 120 to access the accounts held by the user 101. The account database 250 stores transaction history of transactions made by the user 101 using one or more accounts of the user 101, for example, with the banking client application 270, the mobile wallet client application 280, or with other suitable applications.

The financial institution computing system 242 includes a mobile wallet account database 252 for storing mobile wallet accounts of users, including the user 101. The mobile wallet accounts permit payments via a mobile wallet client application 280 of the user device 110. The mobile wallet account database 252 stores transaction history of transactions made by the user 101 using the mobile wallet client application 280.

The financial institution computing system 242 includes a financial indicator management circuit 260. The financial indicator management circuit 260 is capable of determining the financial indicator for the potential transaction in the manner described. The financial indicator management circuit 260 is operatively coupled to one or more of the components of the financial institution computing system 242. For example, the financial indicator management circuit 260 is coupled to the network interface 248 for communicating with one or more of the user device 110, the computing system 130, or the computing system of the non-publically traded company 150 via the communication network 120. The financial indicator management circuit 260 can request and receive transaction history stored in one or more of the transaction information databases 160b and 160c via the communication network 120.

In some examples, the financial indicator management circuit 260 is implemented with the processor 244. For example, the financial indicator management circuit 260 can be implemented as a software application stored within the memory 246 and executed by the processor 244. Accordingly, such examples can be implemented with minimal or no additional hardware costs. However, other implementations rely on dedicated hardware specifically configured for performing operations of the financial indicator management circuit 260.

The financial indicator management circuit 260 is coupled to one or more of the account database 250 or mobile wallet database 252 to access information stored thereon with respect to the transaction history of the user 101. As described, transaction information related to the potential transaction (completed or incomplete) can be stored in the financial information database 160a as a part of the transaction history of the non-publically traded company 150.

In some arrangements, the financial institution computing system 242 includes or is otherwise operatively coupled to the transaction information databases 160a.

As shown, the user 101 operates or is associated with the user device 110. In some arrangements, the user device 110 includes a processing circuit 202 having a processor 203 and memory 204. The processor 203 is implemented as a general-purpose processor, an ASIC, one or more FPGAs, a DSP, a group of processing components that are distributed over various geographic locations or housed in a single location or device, or other suitable electronic processing components. The memory 204 (e.g., RAM, NVRAM, ROM, Flash Memory, hard disk storage, etc.) stores data and/or computer code for facilitating the various processes described herein. Moreover, the memory 204 is or includes tangible, non-transient volatile memory or non-volatile memory. Accordingly, the memory 204 includes database components, object code components, script components, or any other type of information structure for supporting the various activities and information structures described herein.

The user device 110 is shown to include various circuits and logic for implementing the activities described herein. More particularly, the user device 110 includes one or more of a processing circuit 202, input/output circuit 205, network interface 206, financial indicator circuit 220, banking client application 270, mobile wallet client application 280, or the like. While various circuits, interfaces, and logic with particular functionality are shown, it should be understood that the user device 110 includes any number of circuits, interfaces, and logic for facilitating the functions described herein. For example, the activities of multiple circuits are combined as a single circuit and implemented on a same processing circuit (e.g., the processing circuit 202), as additional circuits with additional functionality are included.

The network interface 206 is configured for and structured to establish a communication session via the communication network 120 with the financial computing system 242. Accordingly, the network interface 206 is an interface such as, but not limited to, the network interface 248.

The input/output circuit 205 is configured to receive user input from and provide information to the user 101. In this regard, the input/output circuit 205 is structured to exchange data, communications, instructions, etc. with an input/output component of the user device 110. Accordingly, in some arrangements, the input/output circuit 205 includes an input/output device such as a display device, touchscreen, keyboard, microphone, and/or the like. In some arrangements, the input/output circuit 205 includes communication circuitry for facilitating the exchange of data, values, messages, and the like between the input/output device and the components of the user device 110. In some arrangements, the input/output circuit 205 includes machine-readable media for facilitating the exchange of information between the input/output device and the components of the user device 110. In still another arrangement, the input/output circuit 205 includes any combination of hardware components (e.g., a touchscreen), communication circuitry, and machine-readable media.

One or more of the banking client application 270 or mobile wallet client application 280 are server-based applications executable on the user device 110. In this regard, the user 101 has to first download the application(s) prior to usage. In another arrangement, the banking client application 270 and/or mobile wallet client application 280 are coded into the memory 204 of the user device 110. In still another arrangement, the banking client application 270 and/or mobile wallet client application 280 are web-based interface applications. In this configuration, the user 101 has to log onto or otherwise access the web-based interface before usage. In this regard, at least one of the banking client application 270 and mobile wallet client application 280 is supported by a separate computing system comprising one or more servers, processors, network interface modules, etc. that transmit the applications for use to the user device 110. In certain arrangements, one or more of the banking client application 270 and/or mobile wallet client application 280 include an Application Programming Interface (API) and/or a Software Development Kit (SDK) that facilitate integration of other applications. All such variations and combinations are intended to fall within the spirit and scope of the present disclosure.

The banking client application 270 is communicably coupled to the financial institution computing system 242 (e.g., the account database 250) via the network 202 and is structured to permit management of at least one account of the user 101 via the banking client application 270. In this regard, the banking client application 270 provides displays indicative of account information such as, but not limited to, current account balances, pending transactions, profile information (e.g., contact information), reward associated with the account, bill pay information and/or the like. Further, in some arrangements, the banking client application 270 is configured to process payments from the user 101 to a designated recipient. For example, the banking client application 270 depicts a loan (e.g., mortgage) of the user 101 and allows the user 101 to pay the loan from an account (e.g., checking or savings). In some examples, a bill pay option is provided by the banking client application 270, where the bill pay option allows the user 101 to pay his/her bills in response to user input.

As mentioned herein, via the banking client application 270, the user 101 pays bills (e.g., mortgage, etc.), view balances, pays merchants, and otherwise manage their account. Accordingly and as shown, the mobile bank client application 270 includes an account information circuit 214. The account information circuit 214 is linked or otherwise coupled to one or more accounts (as stored in the account database 250) held by the user 101 and permit management of the associated accounts (e.g., transfer balances between accounts, view payment history, etc.) by communicating with the financial institution computing system 242. The banking client application 270 is communicably coupled to the mobile wallet client application 280. As such, in response to a mobile payment via the mobile wallet client application 280, the mobile wallet client application 280 causes the banking client application 270 to update the payment account (i.e., the account that supported the mobile payment). As such, the applications 270 and 280 are communicably coupled to each other to enable actions supported by each respective application.

The mobile wallet client application 280 is communicably coupled to the financial institution computing system 242 (e.g., the mobile wallet database 252) via the communication network 120 and is structured to facilitate purchases by the user 101 via the mobile wallet client application 280. Accordingly, the mobile wallet client application 280 is linked or otherwise connected with one or more accounts (as stored in the account database 250) of the user 101. In operation, when at a point-of-sale terminal, the user 101 initiates the mobile wallet client application 280 and provides a passcode (e.g., biometrics such as a thumbprint, a Personal Identification Number (PIN), a password, etc.) to authenticate the user 101 and select the source payment account desired (e.g., a checking account from a particular financial institution that is linked to the mobile wallet client application 280). Via communication with the payment terminal (e.g., via near field communication), the aforementioned payment information is provided to the POS terminal or the merchant (e.g., via NFC, via barcode presentment, etc.) and the payment is processed. Beneficially, carrying payment cards are avoided or reduced via the mobile wallet client application 280.

As mentioned herein, the mobile wallet client application 280 is structured to facilitate and permit payments by interfacing with an account held by the user 101 at the financial institution 140. Accordingly, the mobile wallet client application 280 is communicably coupled via the network interface 206 over the communication network 120 to the financial institution computing system 242. As shown, the mobile wallet client application 280 includes a payment processing circuit 216 structured to facilitate payments by the user 101 via the mobile wallet client application 280. For example, the payment processing circuit 216 enables a quick-pay capability with a merchant. In this regard, the payment processing circuit 216 includes or is communicably coupled with a communication device (e.g., a near-field communication chip) that facilitates the exchange of information between the mobile wallet client application 280 and a POS terminal.

In some arrangements, the user device 110 includes a financial indicator circuit 220. The financial indicator circuit 220 is operatively coupled to one or more of the components of the user device 110. For example, the financial indicator management circuit 260 is coupled to the network interface 206 for communicating financial indicators and related messages with the financial institution computing system 242 via the communication network 120. In some examples, the financial indicator circuit 220 is coupled to the input/output circuit 205 to display and receive user input concerning the financial indicator to the user 101.

FIG. 3 is a flow diagram illustrating a method 300 for determining a financial indicator according to various arrangements. Referring to FIGS. 1-3, the method 300 is generally initiated when the financial institution computing system 242 receives a request message from the user device 110 indicating that the potential transaction has been initiated. In other examples, the method 300 is initiated before any transaction is entered into, and the financial indicator is provided independent of any particular transaction. As a response, the financial indicator management circuit 260 determines a financial indicator based on the transaction history of the non-publically traded company 150 and sends the financial indicator to the user device 110 to be presented to the user 101 before the transaction amount is paid to the non-publically traded company 150.

At 305, the financial indicator circuit 220 of user device 110 configures the network interface 206 to send over the communication network 120 a request message (indicating that the user 101 is initiating the potential transaction with the non-publically traded company 150 or the user 101 is considering to enter into a potential transaction with the non-publically traded company 150) to the financial institution computing system 242. In some arrangements, the input/output circuit 205 of the user device 110 receives user input from the user 101 indicating that the user 101 is initiating the potential transaction with the non-publically traded company 150. According to a non-limiting example, the user input includes scanning a Quick Read (QR) code or Radio Frequency Identification (RFID) tag on a product sold by the non-publically traded company 150. According to another non-limiting example, the user input includes activating a user interactive element (e.g., a button) on a website of the non-publically traded company 150 that corresponds to a product or service offered by the non-publically traded company 150.

The user device 110 can support payments via electronically stored credit/debit card information, online payment/money transfer applications, third party digital payment services, browser-based payments, or the like. According to a non-limiting example, the mobile wallet client application 280 or the banking client application 270 is activated by the user 101 via the input/output circuit 205 to digitally pay for goods or services offered by the non-publically traded company 150 without using cash and without using physical credit/debit cards.

In response to receiving user input that can be used to identify the non-publically traded company 150, the financial indicator circuit 220 sends the request message to the financial institution computing system 242. In some configurations, the request message includes one or more of a name, address, and/or code identifying the non-publically traded company 150. In some configurations, the request message includes a name or code of a product/service that is sold by the non-publically traded company 150.

The request message is sent prior to the potential transaction being completed (e.g., before digital payments are processed or made to the non-publically traded company 150). In some examples, in response to sending the request message, the financial indicator circuit 220 is configured to prevent the user 101 from completing the transaction. According to a non-limiting example, in response to receiving the user input that can be used to identify the non-publically traded company 150, the financial indicator circuit 220 configures the input/output circuit 205 to deactivate user interactive elements (e.g., a button that says “PAY NOW!” or “CHECKOUT” or text fields that receive payment information from the user 101) that, if activated, will allow the payments to be made to the non-publically traded company 150.

FIG. 4A and FIG. 4B are interface display diagrams illustrating interactive interfaces 400a and 400b for receiving user input in connection with the method 300 (FIG. 3) according to some arrangements. Each of the interactive interfaces 400a and 400b is displayed by the input/output circuit 205 of the user device 110. Referring to FIGS. 1-4A, the interactive interface 400a displays a name of the non-publically traded company 150 (“Company A”) and a name of the product (“Gift Card A”) offered by the non-publically traded company 150. The interactive interface 400a further includes a window 410a that requests user input relative to initiating the potential transaction. For instance, selecting element 420a corresponds to receiving user input to initiate the potential transaction with Company A to purchase Gift Card A. Selecting element 430a corresponds to receiving user input to not initiate the potential transaction with Company A to purchase Gift Card A. In the non-limiting example shown in FIG. 4A, block 305 is executed in response to selecting element 420a.

Referring to FIGS. 1-4B, the interactive interface 400b requests user input relative to obtaining the financial indicator. The interactive interface 400b displays a name of the non-publically traded company 150 (“Company X”) and a name of the good or service (“Service X”) offered by the non-publically traded company 150. The interactive interface 400b further includes a window 410b that requests user input relative to initiating the potential transaction. For instance, selecting element 420b corresponds to receiving user input to view the financial indicator for Company X. Selecting element 430b corresponds to omitting to send the request for the financial indicator. In the non-limiting example shown in FIG. 4B, block 305 is executed in response to selecting element 420b.

Returning to FIGS. 1-3, at 310, the financial institution computing system 242 receives the request message from the user device 110. The request message indicates that the user 101 wishes to initiate or at least is considering to enter into the potential transaction with the non-publically traded company 150. The request message is received before the completion of the potential transaction or before the initiation of the transaction. The financial indicator management circuit 260 identifies the non-publically traded company 150 based on the content of the request message, for example, by performing a search on one or more of the financial information databases 160a-160c using the name, address, and/or code identifying the non-publically traded company 150 and/or the name or code of the product/service that is sold by the non-publically traded company 150.

At 320, the financial indicator management circuit 260 determines the financial indicator of the non-publically traded company 150 based on the transaction history of the non-publically traded company 150 in the manner described. Given that the financial information databases 160a-160c are updated continuously with the most recent transactions, the request-driven method as described herein assures that the financial indicator is as up-to-date as possible to allow the user 101 to make the best financial decision possible. In some arrangements, the financial indicator can be a present financial indicator determined based on the transaction history. The present financial indicator indicates a current financial health of the non-publically traded company 150. In some arrangements, the financial indicator can be a future financial indicator determined based on the transaction history. The future financial indicator indicates a projected financial health of the non-publically traded company 150 in the future (e.g., at a future moment in time such as in three months, six months, one year, and so on).

At 330, the financial indicator management circuit 260 configures the network interface 249 to transmit the financial indicator to the user device 110. The financial indicator is transmitted before the completion of the potential transaction. In some examples, financial indicator management circuit 260 configures the network interface 249 to transmit a notification to the user device 110, the notification including the financial indicator and configured to prompt the user 101 to initiate the transaction.

At 315, the network interface 206 of the user device 110 receives the financial indicator, which is determined based on the transaction history of the non-publically traded company 150. At 325, the financial indicator circuit 220 configures the input/output circuit 205 to display the financial indicator to the user 101 before the completion of the potential transaction. Based on the financial indicator, the user 101 may choose to proceed with the transaction if the user 101 believes that financial health that corresponds to the financial indicator is sufficient enough to proceed with the potential transaction with the non-publically traded company 150.

FIGS. 5A-5D are interface display diagrams illustrating interactive interfaces 500a-500d for displaying financial indicators in connection with the method 300 (FIG. 3) according to some arrangements. Each of the interactive interfaces 500a-500d is displayed by the input/output circuit 205 of the user device 110. Referring to FIGS. 1-5A, the input/output circuit 205 displays the interactive interface 500a subsequent to displaying the interactive interface 400a and in response to receiving the financial indicator at 315. The interactive interface 500a includes a window 510a that displays the financial indicator (e.g., a future financial indicator: “87% chance that Company A will continue operations in a year”) for Company A. The future financial indicator is a gradient, a score, or a percentage of viability corresponding to a future time (e.g., one year later). The interactive interface 500a further includes user interactive elements 520a and 530a that are configured to receive user input relative to completing the potential transaction. For instance, selecting element 520a corresponds to receiving user input to proceed with completing the potential transaction with Company A to purchase Gift Card A, for example, by authorizing payment to Company A. Selecting element 530a corresponds to canceling the potential transaction with Company A.

In addition, the interactive interface 500a includes a user interactive element 540a that, in response to being activated, displays a financial indicator of at least one other non-publically traded company in the same industry as that of the non-publically traded company 150. According to a non-limiting example, in response to determining that the element 540a has been selected, the financial indicator circuit 220 sends another request message to the financial institution computing system 242 to request the financial indicator of at least one other non-publically traded company in the same industry. The financial indictor management circuit 260 determines the financial indicator for the at least one other non-publically traded company in the same industry in a similar manner and transmits the same to the user device 110.

Referring to FIGS. 1-5B, the input/output circuit 205 displays the interactive interface 500b subsequent to displaying the interactive interface 400b and in response to receiving the financial indicator at 315. The interactive interface 500b includes a window 510b that displays the financial indicator (e.g., “NO PASS”) for Company X. In addition, the window 510b illustrates the financial indicator of other non-publically traded companies in the same industry as that of the non-publically traded company 150, which is the intended party to the potential transaction. For instance, the window 510b shows that Company Y and Company Z are associated with a financial indicator of “PASS.” In other words, the interactive interface 500b is configured to warn the user 101 or recommend the user 101 to not engage or not complete any transaction with the non-publically traded company 150 in response to the financial indicator being below a threshold.

In some arrangements, the financial indicator management circuit 260 automatically sends identities of the other companies in the same industry and their associated financial indicators with the financial indicator of the non-publically traded company 150 at block 330. The financial indicator management circuit 260 determines that entering into the potential transaction with the non-publically traded company 150 is risky by evaluating the financial indicator of the non-publically traded company 150 against a threshold. In response to determining that the financial indicator falls below the threshold, other companies in the same industry having financial indicators that indicate stronger financial health (e.g., having financial indicators that exceed the threshold or having financial indicators that indicate better financial health) are determined. The identities of the other companies and their associated financial indicators are automatically sent in the manner described, without needing additional user input. User interactive elements 520b and 530b, in response to being selected by the user 101, triggers displaying information related to Company Y and Company Z, respectively. According to a non-limiting example, selecting user interactive element 520b causes the input/output circuit 205 to display a webpage on which the user 101 can purchase services similar to Service X from Company Y. As such, the user 101 is provided with safer choices for purchasing the same or similar products or services immediately upon receiving the financial indicator of the non-publically traded company 150. Network resources corresponding to additional requests for similar merchants and their respective financial indicators are conserved.

The interactive interface 500b further includes user interactive elements 540b and 550b that receive user input relative to completing the potential transaction. For instance, selecting element 540a corresponds to receiving user input to complete the potential transaction with Company X to purchase Service X, for example, by authorizing payment to Company X. Selecting element 550b corresponds to canceling the potential transaction with Company X.

In one example, the user 101 is a customer of the financial institution 140 and uses the banking client application 270 and/or the mobile wallet client application 280 provided by the financial institution computing system 242. In another example, the non-publically traded company 150 is a customer of the financial institution 140 and automatically deposits payments requested in the potential transaction from an account of the user 101 to an account managed by the financial institution computing system 242. In either example, the financial institution computing system 242 processes the payment for the potential transaction in response to the user 101 authenticating the potential transaction. According to non-limiting examples, the user 101 can select elements 520a and 540b to authorize the potential transaction. In some arrangements, the financial institution computing system 242 processes the payment for the potential transaction by issuing a payment token associated with the potential transaction.

Upon successful payment or upon receiving from the user device 101 a transaction status indicator indicating the potential transaction has occurred after the financial indicator is viewed by the user 101, the financial indicator management circuit 260 updates the transaction history corresponding to the non-publically traded company 150 with aspects (e.g., transaction amount, transaction time, periodicity of payment, identity of user 101, product/service, and/or the like) of the potential transaction. Similarly, the financial indicator management circuit 260 can receive a transaction status indicator indicating the potential transaction has not been authorized by the user 101 after the financial indicator is viewed by the user 101, and update the transaction history associated with the non-publically traded company 150 with the aspects of the potential transaction, noting that the transaction was not authorized and therefore did not occur. As such, other customers of the non-publically traded company 150 can appreciate the incremental foresight associated with the completed or failed potential transaction, as a subsequent financial indicator for the non-publically traded company 150 accounts for the aspects of the potential transaction.

Referring to FIGS. 1-5C, the input/output circuit 205 displays the interactive interface 500c subsequent to displaying the interactive interface 400a. In some arrangements, the interactive interface 500c includes a window 510c that displays a prompt for the user 101 to enter a future time, based on which the financial indicator (e.g., a future financial indicator) can be determined. In the non-limiting example shown, the window 510c requests a future time relative to an anticipated usage of Gift Card A. The window 510c further includes a user interactive element 520c for receiving a user response. As shown, the user interactive element 520c is configured as a text field in which a user response (e.g., “6 months”) can be inputted.

In some arrangements, upon receiving the future time, the future time is sent to the financial institution computing system 242. The financial indicator management circuit 260 determines the future financial indicator that corresponds to the future time (e.g., “6 months”) and sends the future financial indicator to the user device 110 (e.g., at 315) to be displayed. In other arrangements, the financial institution computing system 242 sends various future financial indicators of Company A that correspond to different future times (e.g., “within a month—90% pass,” “within 3 months—75% pass,” “within 6 months—50% pass,” “within a year—46% pass,” and the like) to the user device 110. Upon receiving the user-inputted future time (e.g., via the user interactive element 520c), the financial indicator circuit 220 selects one of the various future financial indicators that most closely corresponds to the user-inputted future time.

The interactive interface 500c includes a window 530c that displays the future financial indicator (e.g., “50% chance that Company A will continue operations in 6 months”) that most closely corresponds to the user-inputted future time (e.g., “6 months”) for Company A. The interactive interface 500c further includes user interactive elements 540c and 550c that are configured to receive user input relative to completing the potential transaction. For instance, selecting the user interactive element 540c corresponds to receiving user input to proceed with completing the potential transaction with Company A to purchase Gift Card A, for example, by authorizing payment to Company A. Selecting the user interactive element 550c corresponds to canceling the potential transaction with Company A.

In the event that the user 101 selects the user interactive element 540c to proceed with completing the potential transaction with Company A to purchase Gift Card A (or a payment card, and the like), the user 101 can set an expiration date for Gift Card A via any suitable user interactive elements provided by the input/output circuit 205. The expiration date and the expiration date's correspondence with the associated non-publically traded company 150 is stored in the memory 204. In some implementations, the financial indicator circuit 220 of the user device 110 periodically queries the financial institution computing system 242 for updates to the future financial indicator for Company A. Responsive to the financial indicator circuit 220 of the user device 110 determining a change to the future financial indicator previously presented to the user (e.g., via the window 530c) exceeding a threshold, the input/output circuit 205 displays the interactive interface 500d.

Referring to FIGS. 1-5D, the interactive interface 500d is displayed responsive to the financial indicator circuit 220 determining that a change of the future financial indicator (e.g., “50% chance that Company A will continue operations in 6 months”) exceeds a threshold. Illustrating with a non-limiting example, the user device 110 receives updates from the financial institution computing system 242. The financial indicator circuit 220 compares each update with the future financial indicator displayed to the user 101 to determine a change. Responsive to determining that the change exceeds a threshold (e.g., 1%, 5%, 10%, 20%, or the like), the input/output circuit 205 displays the interactive interface 500d.

The interactive interface 500d includes a window 510d that notifies the user 101 that Gift Card A is anticipated to be used in 3 months. The interactive interface 500d includes a window 520d that shows the updated future financial indicator (e.g., “10% chance that Company A will continue operations in 3 months,” “10% chance that Company A will exist in 6 months”). The interactive interface 500d includes a user element 530d such that, if selected, allows the user 101 to use Gift Card A (e.g., by directing the user 101 to a website that accepts Gift Card A). In other arrangements in which the change indicates a better financial health (e.g., that the probability that Company A will continue operations or exist in 3 months has increased from 10% to 80%), the input/output circuit 205 displays a message informing the user 101 of the improvement and/or provides a user interactive element such that, if selected, allows the user 101 to use Gift Card A (e.g., by directing the user 101 to a website for using Gift Card A).

The arrangements described herein have been described with reference to drawings. The drawings illustrate certain details of specific arrangements that implement the systems, methods and programs described herein. However, describing the arrangements with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some arrangements, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some arrangements, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some arrangements, the one or more processors may be embodied in various ways. The one or more processors may be constructed in a manner sufficient to perform at least the operations described herein. In some arrangements, the one or more processors may be shared by multiple circuits (e.g., circuit A and circuit B may comprise or otherwise share the same processor which, in some example arrangements, may execute instructions stored, or otherwise accessed, via different areas of memory). Alternatively or additionally, the one or more processors may be structured to perform or otherwise execute certain operations independent of one or more co-processors. In other example arrangements, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some arrangements, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the arrangements might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some arrangements, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other arrangements, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example arrangements described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative arrangements. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

The foregoing description of arrangements has been presented for purposes of illustration and description. It is not intended to be exhaustive or to limit the disclosure to the precise form disclosed, and modifications and variations are possible in light of the above teachings or may be acquired from this disclosure. The arrangements were chosen and described in order to explain the principals of the disclosure and its practical application to enable one skilled in the art to utilize the various arrangements and with various modifications as are suited to the particular use contemplated. Other substitutions, modifications, changes and omissions may be made in the design, operating conditions and arrangement of the arrangements without departing from the scope of the present disclosure as expressed in the appended claims.

1. A method of generating a financial indicator of a non-publically traded company, the method comprising:
receiving, by a financial institution computing system from a user device associated with a user, a request message indicating that the user is considering entering into a potential digital transaction with a non-publically traded company to purchase goods or services offered by the non-publically traded company electronically using a first interface displayed by the user device the request comprising a name or code of the goods or services;
determining, by the financial institution computing system, a financial indicator of the non-publically traded company based on private transaction history of the non-publically traded company in response to receiving the request message identifying the non-publically traded company, the financial indicator corresponding to capability of the non-publically traded company to provide the goods or the services; and
transmitting, by the financial institution computing system to the user device, the financial indicator, the financial indicator being displayed in a second interface displayed by the user device to notify the user of the capability of the non-publically traded company to provide the goods or the services.

2. The method of claim 1, further comprising storing, by the financial institution computing system in a financial information database, transaction history of a plurality of non-publically traded companies, wherein the transaction history of the plurality of non-publically traded companies comprises the transaction history of the non-publically traded company.

3. The method of claim 1, wherein
the non-publically traded company is a customer of the financial institution; and
at least a portion of transactions of the transaction history of the non-publically traded company is processed by the financial institution computing system.

4. The method of claim 1, wherein at least a portion of transactions of the transaction history of the non-publically traded company is processed by another financial institution computing system associated with another financial institution.

5. The method of claim 4, further comprising receiving, by the financial institution computing system from the another financial institution computing system, information related to the portion of the transactions shown on the transaction history of the non-publically traded company that is processed by the another financial institution computing system.

6. The method of claim 1, wherein the transaction history of the non-publically traded company is based on previous transactions between the non-publically traded company and entities other than the user.

7. The method of claim 1, wherein the transaction history comprises one or more of transaction data related to previous transactions between the non-publically traded company and customers of the non-publically traded company, cash flow data of the non-publically traded company, liability data of the non-publically traded company, investment data of the non-publically traded company, or profit data of the non-publically traded company.

8. The method of claim 1, further comprising:
receiving a transaction status indicator indicating that the user authorized the potential transaction between the user and the non-publically traded company after the user viewed the financial indicator; and
updating the transaction history associated with the non-publically traded company with information from the potential transaction between the user and the non-publically traded company.

9. The method of claim 1, further comprising:
receiving a transaction status indicator indicating that the user did not authorize the potential transaction between the user and the non-publically traded company after the user viewed the financial indicator; and
updating the transaction history associated with the non-publically traded company with information from the failed potential transaction.

10. The method of claim 8, further comprising:
processing a payment corresponding to the potential transaction in response to the user authorizing the potential transaction.

11. The method of claim 10, wherein processing the payment corresponding to the potential transaction comprises issuing, by the financial institution computing system, a payment token associated with the potential transaction.

12. The method of claim 1, further comprising:
determining that the financial indicator falls below a threshold; and
identifying another non-publically traded company that has an another financial indicator that exceeds the threshold.

13. The method of claim 12, further comprising sending a notification to the user device comprising the identity of the another non-publically traded company and the another financial indicator with the financial indicator of the non-publically traded company.

14. A financial institution computing system, comprising:
a network interface structured to facilitate data communication via a network;
a memory; and
a processing circuit comprising a processor, the processing circuit configured to:
receive, from a user device associated with a user, a request message indicating that the user is considering entering into a potential digital transaction with a non-publically traded company via the user device to purchase goods or services offered by the non-publically traded company electronically using a first interface displayed by the user device, the request comprising a name or code of the goods or services;
determine a financial indicator of the non-publically traded company based on private transaction history of the non-publically traded company in response to receiving the request message identifying the non-publically traded company, the financial indicator corresponding to capability of the non-publically traded company to provide the goods or the services; and
transmit the financial indicator to the user device, the financial indicator being displayed in a second interface displayed by the user device to notify the user of the capability of the non-publically traded company to provide the goods or the services.

15. The financial institution computing system of claim 14, wherein the transaction history of the non-publically traded company is based on previous transactions between the non-publically traded company and entities other than the user.

16. The financial institution computing system of claim 14, wherein the transaction history comprises one or more of transaction data related to previous transactions between the non-publically traded company and customers of the non-publically traded company, cash flow data of the non-publically traded company, liability data of the non-publically traded company, investment data of the non-publically traded company, or profit data of the non-publically traded company.

17. The financial institution computing system of claim 14, wherein the processing circuit is further configured to:
receive a transaction status indicator indicating that the user did not authorize the potential transaction between the user and the non-publically traded company after the user viewed the financial indicator; and
update the transaction history associated with the non-publically traded company with information from the failed potential transaction.

18. The financial institution computing system of claim 16, wherein the processing circuit is further configured to:
process payment corresponding to the potential transaction in response to the user authorizing the potential transaction.

19. The financial institution computing system of claim 18, wherein processing the payment corresponding to the potential transaction comprises issuing, by the financial institution computing system, a payment token associated with the potential transaction.

20. The financial institution computing system of claim 14, wherein the processing circuit is further configured to:
determine that the financial indicator falls below a threshold; and
identify another non-publically traded company that has an another financial indicator that exceeds the threshold.

21. The financial institution computing system of claim 20, wherein the processing circuit is further configured to:
send a notification to the user device comprising the identity of the another non-publically traded company and the another financial indicator with the financial indicator of the non-publically traded company.

22. A non-transitory processor-readable medium having processor-readable instructions stored thereon, such that when executed by a processor of a financial institution computing system, cause the financial institution computing system to perform operations, the operations comprising:
receive, from a user device associated with the user, a request message indicating that the user is considering entering into a potential digital transaction with a non-publically traded company via the user device to purchase goods or services offered by the non-publically traded company electronically using a first interface displayed by the user device, the request comprising a name or code of the goods or services, the potential digital transaction being triggered by user input comprising scanning a Quick Read (QR) code or Radio Frequency Identification (RFID) tag on a product, the goods or services comprising the product;
determine a financial indicator of the non-publically traded company based on transaction history of the non-publically traded company in response to receiving the request message identifying the non-publically traded company, the financial indicator corresponding to capability of the non-publically traded company to provide the goods or the services; and
transmit a notification to the user device, the notification including the financial indicator and configured to prompt the user to initiate the potential transaction, the financial indicator being displayed in a second interface displayed by the user device to notify the user of the capability of the non-publically traded company to provide the goods or the services.

23. A method for providing a user a financial indicator of a non-publically traded company prior to the user conducting a transaction with the non-publically traded company, the method comprising:
receiving, by a user device, first user input indicating a potential digital transaction with a non-publically traded company to purchase goods or services offered by a non-publically traded company, the first user input comprises scanning a Quick Read (QR) code or a Radio Frequency Identification (RFID) tag on a product, the goods or services comprising the product;
receiving, via a first interface displayed by the user device, second user input indicating that the user would like to view the financial indicator of the non-publically traded company;
sending, by the user device to a financial institution computing system, a request message indicating that the user is considering entering into the potential digital transaction with the non-publically traded company to purchase the goods or services offered by the non-publically traded company, the request comprising a name or code of the goods or services;
receiving, by the user device from the financial institution computing system, the financial indicator, wherein the financial indicator is determined based on transaction history of the non-publically traded company in response to the financial institution computing system receiving the request message identifying the non-publically traded company, the financial indicator corresponding to capability of the non-publically traded company to provide the goods or the services; and
displaying, by the user device via a second interface, the financial indicator to the user before the user authorizes the potential transaction, the financial indicator notifies the user of the capability of the non-publically traded company to provide the goods or the services.

24. The method of claim 23, further comprising receiving, by the user device via the user interface, user input indicating that the potential transaction between the user and the non-publically traded company is considered.

25. The method of claim 23, further comprising receiving user input to authorize payment to the non-publically traded company after the financial indicator is displayed.

26. The method of claim 23, further comprising receiving user input to cancel the potential transaction after the financial indicator is displayed.

27. The method of claim 23, further comprising:
receiving another financial indicator associated with another non-publically traded company; and
displaying the another financial indicator with the financial indicator associated with the non-publically traded company.

28. The method of claim 27, wherein the another financial indicator is received in response to the another financial indicator representing better financial health as compared to that represented by the financial indicator.

29. The method of claim 23, further comprising recommending the user to not authorize the potential transaction with the non-publically traded company in response to the financial indicator being below a threshold.
